(19) United States
(12) Patent Application Publication
(10) Pub. No.: US 2011/0022610 A1
(43) Pub. Date: Jan. 27, 2011

(54) Systems and Methods for Augmenting Data in a Personal Productivity Application

(76) Inventor: Robert John Simon, San Francisco, CA (US)

Correspondence Address: KANG LIM, 3494 CAMINO TASSAJARA ROAD #436, DANVILLE, CA, 94506, US

(21) Appl. No.: 12/843,009

(22) Filed: Jul. 24, 2010

Related U.S. Application Data
(60) Provisional application No. 61/228,561, filed on Jul. 25, 2009.

(51) Int. Cl. G06F 17/30

(52) U.S. Cl. 707/755; 707/770; 707/E17.005; 707/E17.014

(57) ABSTRACT

A system and method is provided for generating a display, including information from disparate data sources, for presentation on a device. This display takes a user entry in a personal productivity application and augments the data with data gleaned from a variety of additional sources, including local and external datasets. The system first receives a set of ‘values’ and a set of ‘keywords’. The values and keywords may be generated by parsing a user created entry in a personal productivity application. The criteria for what constitutes keywords and values may be configured by the user. The ‘values’ identified are functionally related to the ‘keywords’. This functional relationship is then analyzed in order to generate the types of data to be displayed. Then a search of disparate data sources is performed to compile the needed data. Once all the data is collected it may be aggregated into a single dataset for display on the device. This aggregation may involve prioritizing, including linking, the data for display by relevance, importance and by user preferences.

### RELATED APPLICATIONS

This application claims priority of U.S. Provisional Patent Application No. 61/228,561, filed Jul. 25, 2009, entitled: “Systems and Methods for Augmenting Data in a Personal Productivity Application”, and this priority application is incorporated herein by reference.

### BACKGROUND OF THE INVENTION

The present invention relates to augmenting data within entries to enhance the usefulness of a personal productivity application. More particularly, the present invention relates to a system which is able to parse entries provided by a user in order to identify keywords and values, which may then be cross referenced in order to identify additional data which may be of benefit to the user. The additional data may be located within or independent of the data maintained by the personal productivity application and may be used to augment the entry with related information to enhance the usefulness of the tool.

Currently, personal productivity applications are used every day by individuals to aid in the organization of business and personal activities. These personal productivity applications are typically multifunctional, including calendar functions, notepads, contact information and email services, among other organizational and communication sub-applications. Examples of current popular personal productivity applications include Microsoft® Outlook and Google® Calendar.

Often these personal productivity applications are accessible from personal computers as well as mobile devices, such as a PDA or cell phone. The ability to access and add information into these devices can be somewhat limited by interface constraints, such as limited keys or keyboard size. This makes writing and editing appointments or lengthy entries into the personal productivity application awkward and time consuming.

Hence there is a need for an improved system for entering data into a personal productivity application. Such a system may allow a user of a device with a personal productivity application to more easily generate entries and automatically access relevant supplemental information.

### SUMMARY OF THE INVENTION

To achieve the foregoing and in accordance with the present invention, a system for augmenting data within entries in a personal productivity application is provided. Such a system is enabled to parse entries provided by a user in order to identify keywords and values, which may then be cross referenced in order to identify additional data which may be of benefit to the user. This additional data may then be used to augment the entry by inclusion of contact information, address information, directions, maps and suggestions. The user is able to configure and customize the system both to recognize specified keywords and values considered useful to the user, as well as to augment entries with information of a type and from data sources considered useful to the user.

One embodiment of the system first receives a set of ‘values’ and a set of ‘keywords’. The values and keywords may be generated by parsing the user created entry in a personal productivity application.

Keywords may be predefined in a keyword listing, and values may be names and locations. Additionally, the criteria for what constitutes keywords and values may be configured by the user. These configurations may be stored in a user preferences dataset. The ‘values’ identified are functionally related to the ‘keywords’.

This functional relationship between the values and keywords is then analyzed in order to generate the types of data to be displayed. The types of data to be displayed may include any of contact information, address information, mapping information, directions, and suggestions. Additionally, the data to be displayed may be further effected by configurations in the user preferences.

Once the data to be displayed is determined, the system may undergo a search of disparate data sources to compile the needed data. This data collection step may include querying local contact databases for contact information and address information associated with the values, as well as, querying external reference databases for mapping information, directions, and suggestion information. The databases used in this search may also be configured within the user preferences.

Once all the data is collected, it may be aggregated into a single dataset for display on the device. This aggregation may involve prioritizing the data for display by relevance, importance and by user preferences. In some embodiments, visually bulky or extraneous data may be presented as a link to the user on the display rather than presenting the data in a raw form. The user may then access more detailed and complete data by actively selecting the link.

Note that the various features of the present invention can be practiced alone or in combination. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A illustrates an example of a first embodiment of the system for augmenting personal productivity application data entries, in accordance with some embodiment of the invention;

FIG. 1B illustrates an example of another embodiment of the system for augmenting personal productivity application data entries, in accordance with some embodiment of the invention;

FIG. 1C illustrates an example of yet another embodiment of the system for augmenting personal productivity application data entries, in accordance with some embodiment of the invention;

FIG. 2 illustrates an embodiment of the personal productivity assistant of the system for augmenting personal productivity application data entries, in accordance with some embodiment of the invention;

FIG. 3 illustrates an example of a flow diagram for the creation and configuration of an account associated with the personal productivity assistant, in accordance with some embodiment of the invention;

FIG. 4 illustrates an example of a flow diagram for augmenting an entry with contact, address and suggestion data, in the personal productivity application, in accordance with some embodiment of the invention;

FIGS. 5 through 9 provide example screen shots for the creation of an account with the personal productivity assistant, in some embodiment of the present invention;

FIG. 10 provides a first example screen shot of a user entry in the personal productivity application, in some embodiment of the present invention;

FIG. 11 provides an example screen shot of the entry of FIG. 10 after being processed by the personal productivity assistant, in some embodiment of the present invention;

FIG. 12 provides another example screen shot of a user entry in the personal productivity application, in some embodiment of the present invention;

FIG. 13 provides an example screen shot of the entry of FIG. 12 after being processed by the personal productivity assistant, in some embodiment of the present invention;

FIG. 14 provides an example screen shot of a message relayed to a mobile device in response to the entry of FIG. 12 after being processed by the personal productivity assistant, in some embodiment of the present invention;

FIG. 15 provides another example screen shot of a user entry in the personal productivity application, in some embodiment of the present invention;

FIG. 16 provides an example screen shot of the entry of FIG. 15 after being processed by the personal productivity assistant, in some embodiment of the present invention;

FIG. 17 provides an example screen shot of a message relayed to a mobile device in response to the entry of FIG. 15 after being processed by the personal productivity assistant, in some embodiment of the present invention;

FIG. 18 provides an example screen shot of an update message relayed to a mobile device in response to a selection made by the user, in some embodiment of the present invention;

FIG. 19 provides another example screen shot of a user entry in the personal productivity application, in some embodiment of the present invention;

FIG. 20 provides an example screen shot of the entry of FIG. 19 after being processed by the personal productivity assistant, in some embodiment of the present invention; and

FIG. 21 provides another example screen shot of the entry of FIG. 19 after being processed by the personal productivity assistant, in some embodiment of the present invention;

In the drawings, like reference numerals are sometimes used to designate like structural elements. It should also be appreciated that the depictions in the figures are diagrammatic and not to scale.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

### I. System and Method

To achieve the foregoing and in accordance with the present invention, a system for augmenting data within entries in a personal productivity application is provided. Such a system is enabled to parse entries provided by a user in order to identify “keywords” and “values”, which may then be cross referenced in order to identify additional data which may be of benefit to the user. This additional data may then be used to augment the entry by inclusion of contact information, address information, directions, maps and suggestions.

The user also able, in some embodiments, to configure and customize the system both to recognize specified keywords and values considered useful to the user, as well as to augment entries with information of a type and from data sources considered useful to the user.

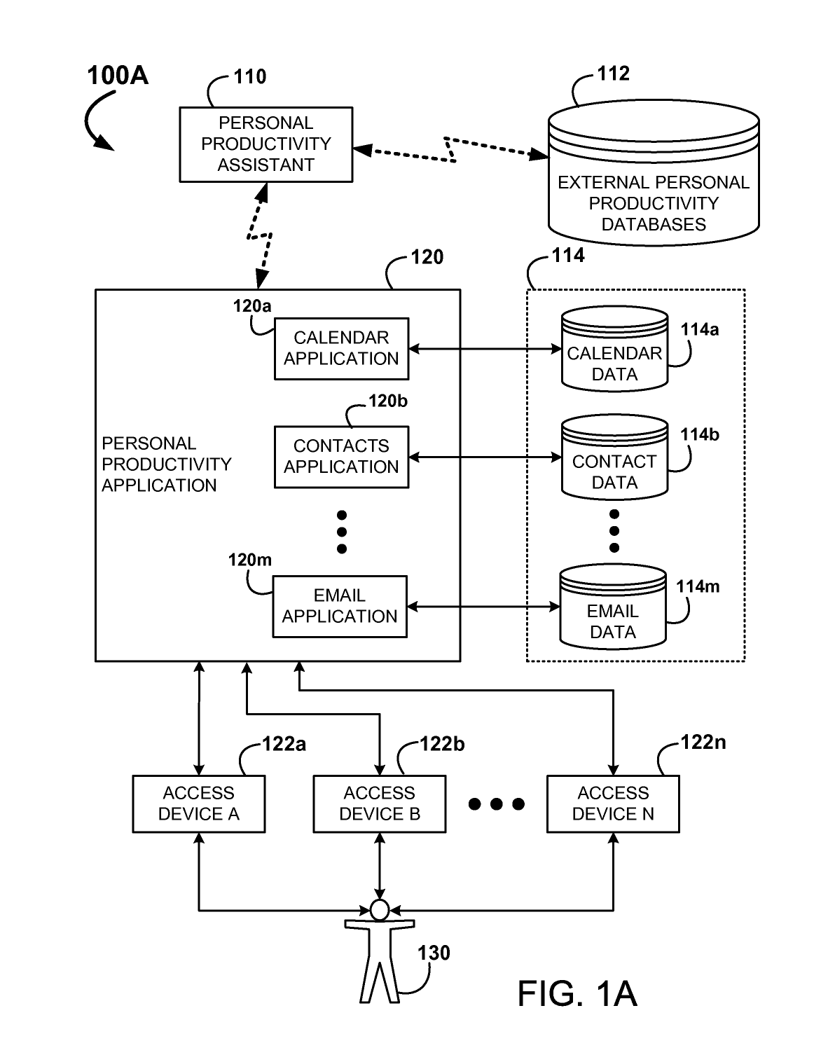

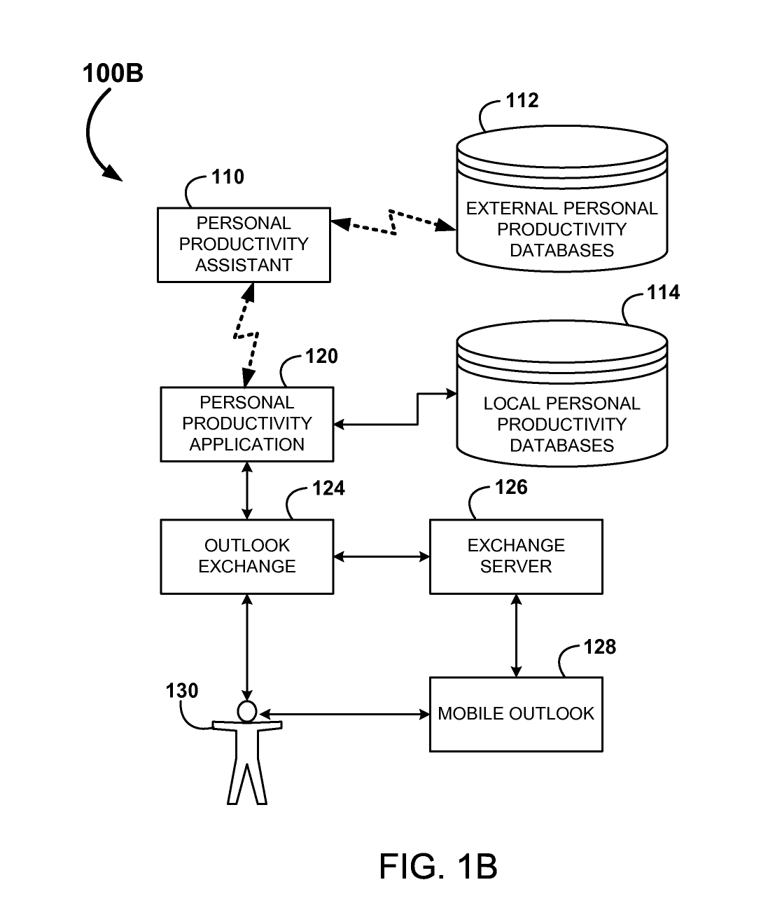

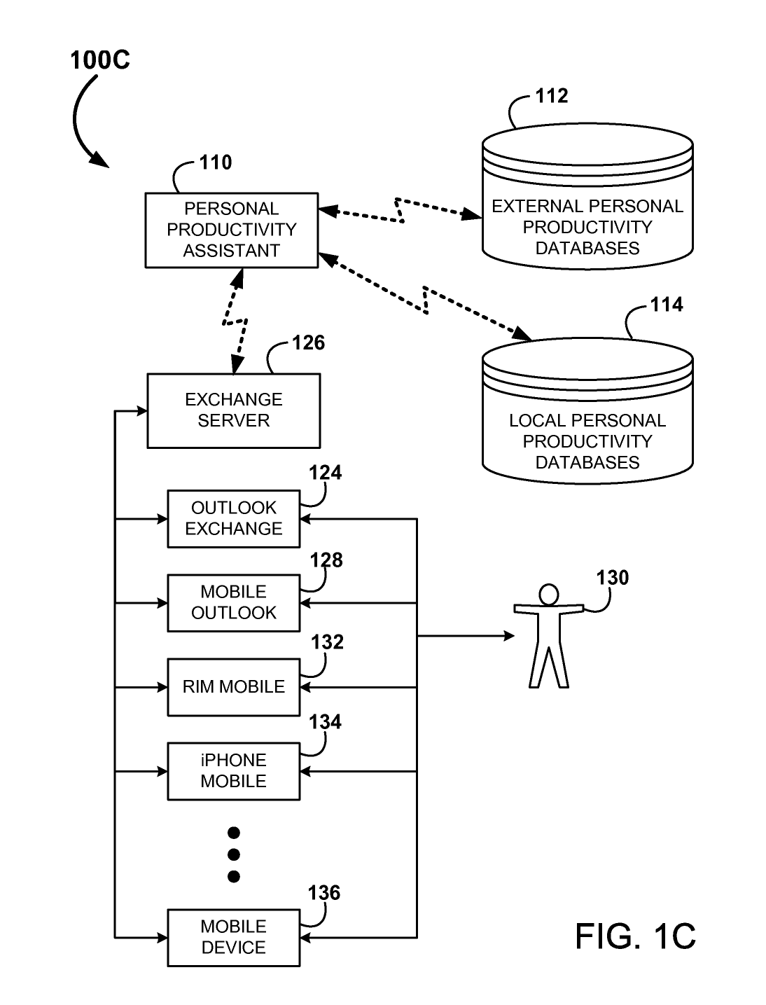

To facilitate discussion, FIG. 1A illustrates an example of a first embodiment of the system for augmenting personal productivity application data entries, shown generally at 100A. Here a User 130 has access to multiple Access Devices 122a, 122b to 122m. The Access Devices 122a, 122b to 122m may host or synchronize with the Personal Productivity Application 120. The Personal Productivity Application 120 may include a Calendar Application 120a, a Contact Application 120b and an Email Application 120m. The Personal Productivity Application 120 may access Local Personal Productivity Databases 114. The Local Personal Productivity Databases 114 may include a Calendar Database 114a, a Contact Database 114b and an Email Database 114m. The Calendar Database 114a, Contact Database 114b and Email Database 114m may provide data to the Calendar Application 120a, Contact Application 120b and Email Application 120m, respectively. Of course, additional applications may be included in the Personal Productivity Application 120 with corresponding database structures. For example, the Personal Productivity Application 120 may also include an instant messenger application, notepad application, or any other reasonable functionality.

A Personal Productivity Assistant 110 may couple to the Personal Productivity Application 120. This connection may be across a direct connection, a Local Area Network (LAN), Wide Area Network (WAN), or the internet. The Personal Productivity Assistant 110 may receive entries made in the Personal Productivity Application 120 by the User 130 over one of the Access Devices 122a, 122b to 122m. The Personal Productivity Assistant 110 may then augment the entry by populating it with additional data, including, but not limited to, contact information, address information, maps, directions, photos, text files, suggestions or any other useful information related to the objects of the entry.

This augmentation may be performed by parsing the inserted entry for “keywords” and “values”. Often, one or more of the values are associated with each keyword.

A “keyword”, for purposes of this disclosure, includes a listing of user and system activities which provide information as to what the entry is immortalizing. For example, a particular entry may, in some embodiment, state “meet John Doe at Outback for lunch.” Here the keyword is ‘meet’ as it denotes the activity the user is engaging in or wishes a response to. Keywords may be identified by comparing each word in the entry to a listing of predefined keywords. An example of a keyword list could include “meet”, “call”, “directions”, directions to”, “nearby”, “map” and “address”. Of course, additional, or fewer, keywords may be configured in the Personal Productivity Assistant 110 in any particular embodiment. Moreover, in some embodiments, the user may configure the keyword list to match her particular needs.

Returning to the above example, ‘values’ may be identified which relate to the identified keyword ‘meet’. Particularly, names and locations are identified as ‘values’. Here, ‘John Doe’ is recognized as the first value, and “Outback” is recognized as the second value.

Again, values may be configured by the user to include not only name and location data, but also time specific activities and the like. This high level of customability enables the Personal Productivity Assistant 110 to be highly reactive to a particular users needs and desires.

Note that location information may be presented in street address form (i.e. 123 Nowhere Street, Oblivion, Calif. 94565) or may be a descriptor for the location. A descriptor of the location may include a name, landmark or business, such as in the above example. When a location is provided, it is common that there is some degree of uncertainty as to the exact location intended by the user. The Personal Productivity Assistant 110 may utilize information as to the user's current location and likely future locations to determine the proper street address for an ambiguous location designator. This may be performed by GPS systems (when the user's device includes GPS capabilities) or may be performed by comparing home and work addresses to the possible locations. Returning then to the example, there are currently 63 Outback Steakhouse establishments in California. The “Outback” value in the entry may refer to any of these locations; however, by comparing the user's current, home, work or most recent locations to the locations of these 63 restaurants, the proper restaurant location may be readily identified.

Once both values and keywords have been identified, they may be correlated in order to determine the data type that the Personal Productivity Assistant 110 will populate the entry with. Thus, for the above example, the keyword ‘meet’ signifies that a person value (John Doe) is of interest. That individual's contact information, including telephone numbers may then be added by the Personal Productivity Assistant 110 to the entry. Likewise, the keyword ‘meet’ sometimes includes a location preceded by the term “at”. The map for and address of this location may then also be collected and used to populate the entry.

The Personal Productivity Assistant 110 may access the Local Personal Productivity Databases 114 via the Personal Productivity Application 120 in order to facilitate the augmentation of the entries. Additionally, the Personal Productivity Assistant 110 may access External Personal Productivity Databases 112 in order to augment the entry with a wider range of data. For example, in some embodiments, the External Personal Productivity Databases 112 may be an internet search site capable of accessing any number of public databases. Thus, an entry involving a meeting at a particular restaurant may be augmented with information from an opinion website (such as yelp.com) in order to provide the user with ordering recommendations. Additionally, in this example, a map of the region surrounding the restaurant may be located on Google maps and presented.

Of course, the External Personal Productivity Databases 112 may include any external data source, including, but not limited to, periodical databases, a corporate server, mapping software such as Microsoft® Streets and Trips, university databases or public record databases, to name a few.

FIG. 1B illustrates an example of another embodiment of the system for augmenting personal productivity application data entries, shown generally at 100B. This variation of the system is similar to the above embodiment. The primary difference in this embodiment is the reliance upon the Exchange Server 126. Thus, the Personal Productivity Application 120 may be accessible on by Outlook Exchange 124. The Outlook Exchange 124 may then access the Outlook Exchange 124 and synchronize a device running Mobile Outlook 128 to the Outlook Exchange 124.

FIG. 1C illustrates an example of yet another embodiment of the system for augmenting personal productivity application data entries, shown generally at 100C. Like the previous embodiment, this system relies upon an Exchange Server 126 for synchronizing and support for various applications and devices. Particularly, the Exchange Server 126 may support Outlook Exchange 124, Mobile Outlook 128, RIM Mobile 132, iPhone Mobile 134, or any other Mobile Device 136. The Personal Productivity Assistant 110 may be coupled to the Exchange Server 126 directly as there is no intermediary personal productivity application. In this embodiment, the Personal Productivity Assistant 110 may access the Local Personal Productivity Databases 114 directly, or through the Exchange Server 126 (not illustrated).

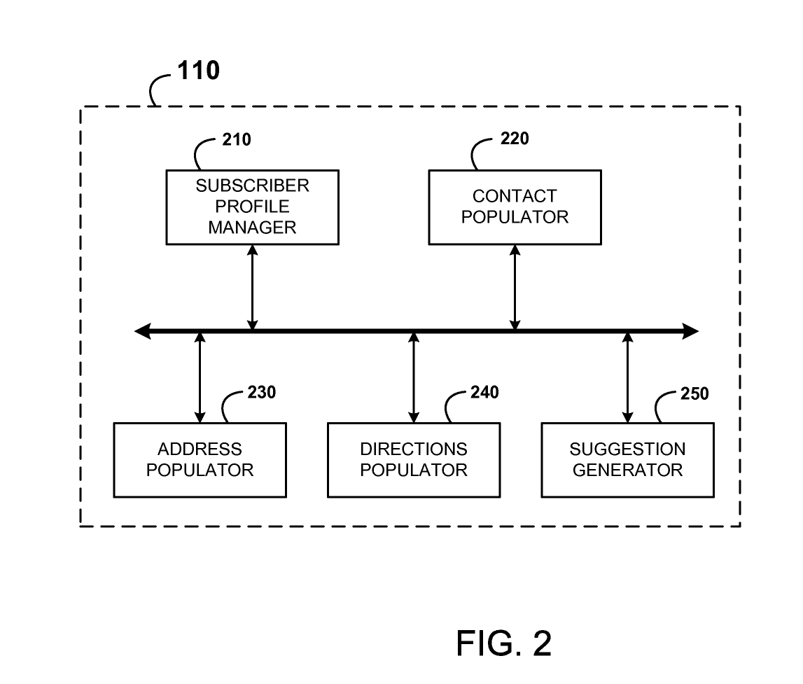

FIG. 2 illustrates an embodiment of the Personal Productivity Assistant 110. The Personal Productivity Assistant 110 may include any of a software module running on a general purpose computer system, a dedicated processor with firmware installed, a server system or any other know computerized architecture. Thus the Personal Productivity Assistant 110 may be entirely software, entirely hardware, or some combination of the two. The Personal Productivity Assistant 110 may include five components each coupled to one another. These components include a Subscriber Profile Manager 210, a Contact Populator 220, an Address Populator 230, a Directions Populator 240 and a Suggestion Generator 250.

The Subscriber Profile Manager 210 may enable the user to access and edit their accounts with the Personal Productivity Assistant 110. Billing and database management may also be performed by the Subscriber Profile Manager 210. As part of account management, the system includes the ability for the user to set “user preferences”. These user preferences enables the user to configure and customize the system both to recognize specified keywords and values considered useful to the user, as well as to augment entries with information of a type and from data sources considered useful to the user. Prioritization of display of augmented data may also be set in user preferences.

The remaining four modules generate and output the data which is used to augment the entry. The Contact Populator 220 may access the Local Personal Productivity Databases 114 and pull contact information for name “values” located in the entry. This information may include phone numbers, addresses for the individuals, email addresses, and personal notes regarding the contact. The Address Populator 230 may determine locations parsed from the entry. The Address Populator 230 may also provide an address for the location, including looking up the location on the internet or other External Personal Productivity Databases 112. Likewise, the Directions Populator 240 may take this address information and generate one or more of a map and step by step directions to the location. Again, the Directions Populator 240 may rely heavily upon data located on the External Personal Productivity Databases 112. Finally, the Suggestion Generator 250 may cross reference the time of the entry, user preferences and location information to generate suggestions for the user. Such suggestions may include dining opportunities (especially at mealtimes), parking locations (especially in crowded downtown locations), mass transit schedules, gas stations, traffic alerts or other relevant and desirous information.

In addition, to addition of entry information in a static nature, real-time updates to the entries may be provided by constant entry data updates, or updates sent to the user by SMS messaging or email messaging. This kind of real-time updating may be particularly helpful when providing the user with traffic information, alternate routes or changes in starting points for driving directions. The system may be further configured to present multiple options to the user on the best manner to get to a given location, such as shortest route, most scenic route, least time route, and routs which leverage mass transit, such as ferry or train services.

In addition to route updates, real-time updating makes a wealth of information available to the user. For example, the system may provide updates on parking availability in parking garages even after the user has left for her destination. The system may even be configured to obtain reservations at parking garages, restaurants and hotels. In some embodiments, these reservation may include prepayment by linking the system to a credit card or bank account.

All of this foregoing augmenting data may, in some embodiments, be prioritized, in relation to the user preferences, data area (when viewed graphically), device viewing area, data size (memory), and data type. This prioritization may determine the order of which data is populated into the entry, as well as determining if the data is presented in its raw form, or as a link. The link, which may be a hyperlink, may enable the user to readily access useful information without it cluttering the screen of the device the user is suing to view the entry. For example, mapping information, which takes up a large area on a device screen, may be provided as a link, and the user may actively open the map when it is desirous, but otherwise allow the map to remain minimized.

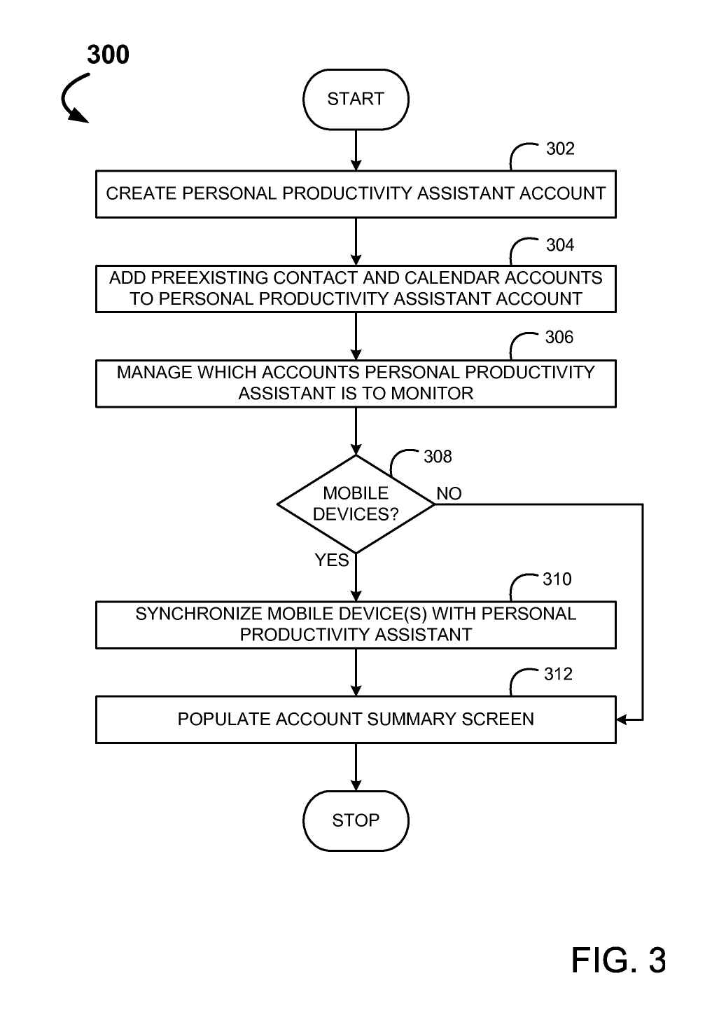

FIG. 3 illustrates an example of a flow diagram for the creation and configuration of an account associated with the personal productivity assistant, shown generally at 300. The method starts and progresses to step 302 where the personal productivity assistant account is created by the user. This account generation includes, in some embodiments, the generation of login information, billing information and user preferences. User preferences may include information that the user desires to have automatically populated into her entries, as well as situations where particular data may be desired. Also, the user may configure keyword lists and values which the system is designed to identify. For example, a user may desire to have gas station nearby a particular location added to entries for locations over a particular distance from home. Thus, the user is not burdened by an overdose of unnecessary information in territory she is familiar with; but in new cities, where the user is less familiar, gas station information may be more relevant.

The process then progresses to step 304 where preexisting contact and calendar accounts are linked or added to the personal productivity assistant account. Thus, the Personal Productivity Assistant 110 may access the External Personal Productivity Databases 112 through the existing Personal Productivity Application 120. Additionally, preexisting entries may be uploaded from these old accounts for data augmentation.

Then, at step 306, the accounts to be monitored and augmented by the Personal Productivity Assistant 110 are selected. This enables the user to have accounts which may be accessed by the Personal Productivity Assistant 110 for contact information, but which do not have additional data augmenting the entries. For example, a user may wish her mobile devices have data augmented into the entries on these machines, but may desire that entries made on her desktop not be augmented.

Then, the process undergoes a decision whether a mobile device is being utilized, a step 308. If there is a mobile device linked to the Personal Productivity Assistant 110, then the device is synchronized with the Personal Productivity Assistant 110 at step 310. If there are no mobile devices, of after such devices have been synchronized, then the process progresses to step 312 where an account summary screen is generated and presented to the user. The process then ends.

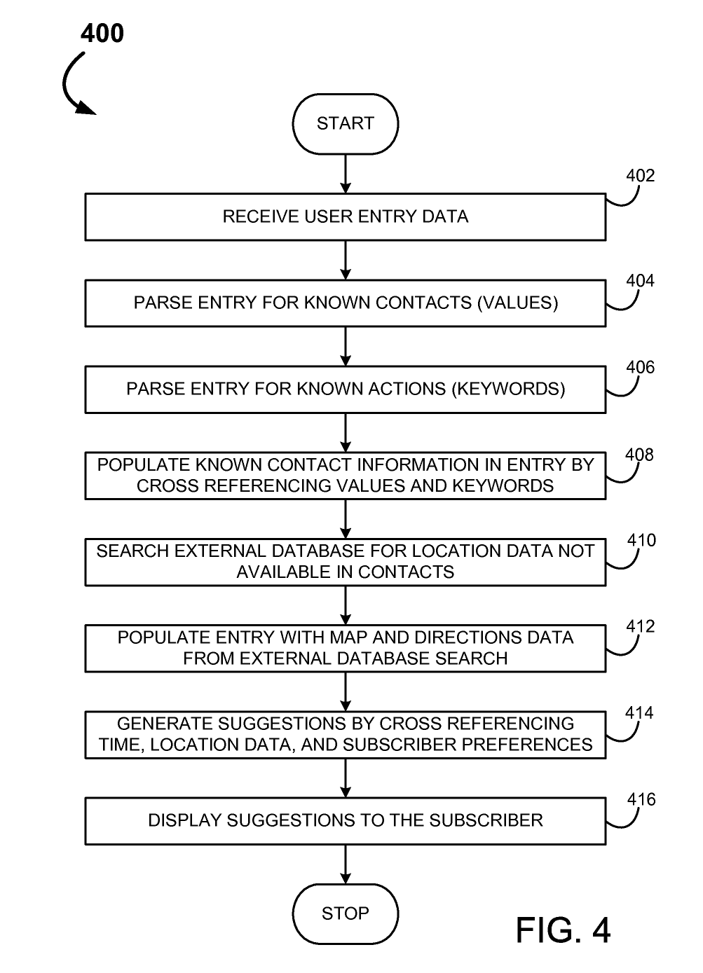

FIG. 4 illustrates an example of a flow diagram for augmenting an entry with contact, address and suggestion data, in the personal productivity application, shown generally at 400. This process assumes that the user has already generated a user account as discussed in the last figure. The process of augmenting the entry begins at step 402 where the system receives an entry which has some data inserted by the user. This entry may be parsed, for ‘values’ (names and locations) and for ‘keywords’ (predefined word list) at steps 404 and 406, respectively. Often one or more values may be linked to a corresponding keyword. In some embodiments, the entries may include “fields” which are intended to include specific information. These fields may be of particular use in determining values. For example, an entry may include a “where” field. Any user input into this field will be assumed a location ‘value’ by the system, in some embodiments.

The keywords and values may be cross referenced to generate the types of information the augmentation should include. Contact information found in the local databases may then be used to populate (augment) the entry, at step 408. This information typically includes phone, email, address and notes on particular individuals. Likewise, additional information, such as location data may be collected from external reference databases and be used to populate the entry at step 410. Likewise, direction information and maps may also be garnered from external databases for augmentation o the entry, at step 412. As previously noted, the internet may be utilized as the external database, as the internet has a wealth of information in a readily digestible format.

At step 414, suggestions may be generated for the entry. These suggestions may be generated by referencing the entry time, location data and subscriber (user) preferences. Examples of suggestions may include, as previously noted, hotel locations, dining opportunities, gas station locations, parking availability, and traffic alerts, among a number of other suggestions. These suggestions may then be displayed to the user at step 416 in the form of an entry augmentation, or other alert mechanism such as instant messages.

While not explicitly illustrated, the present system may also prioritize the display of all the augmentation information, such that the most relevant information is presented first, and items which do not need to be displayed are illustrated as links so that the user may readily enlarge these pieces of data when desirous.

### II. Examples

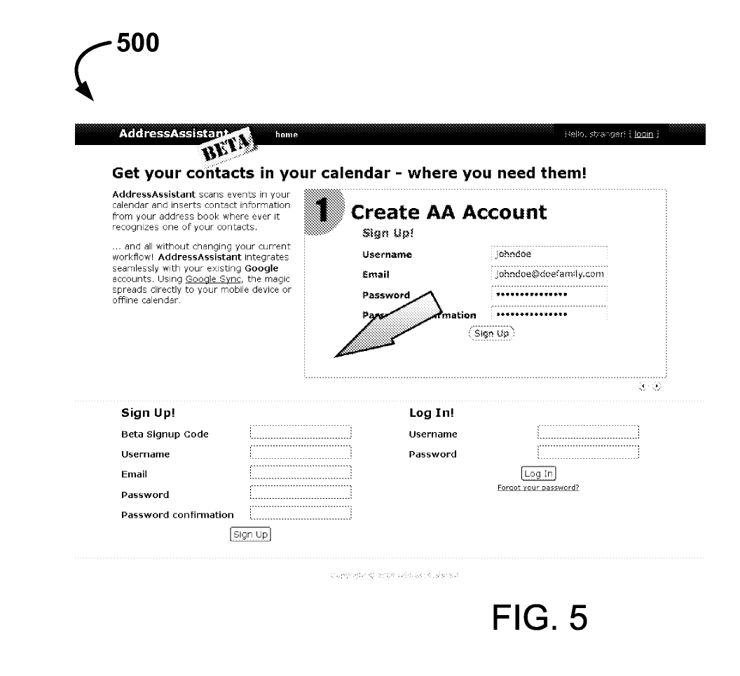

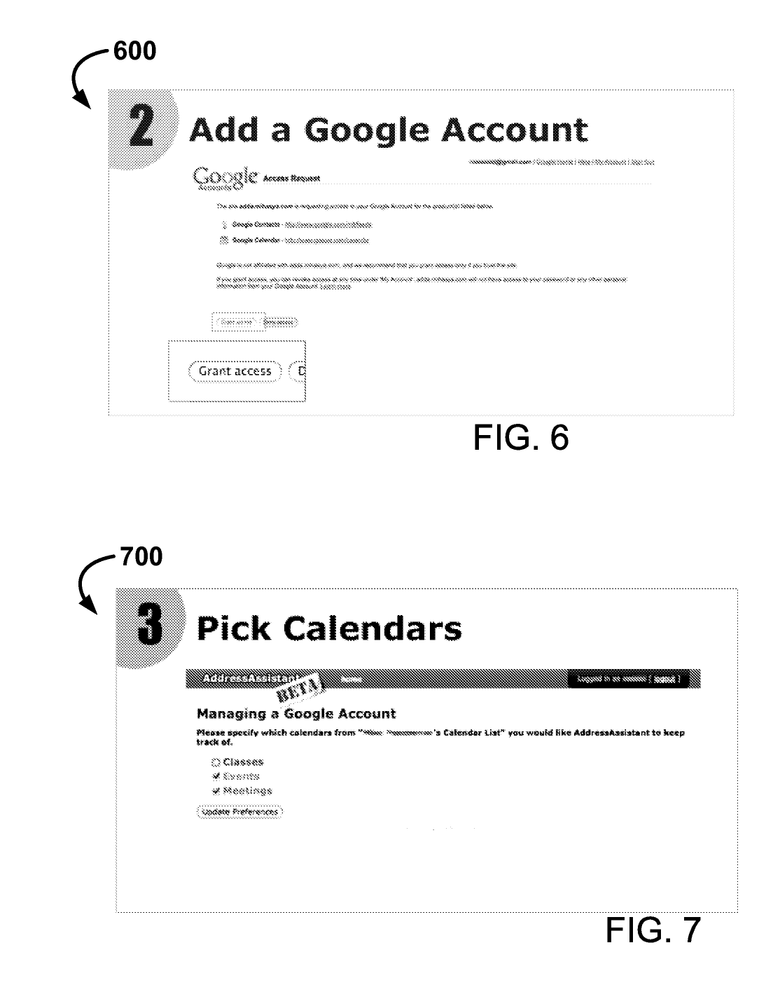

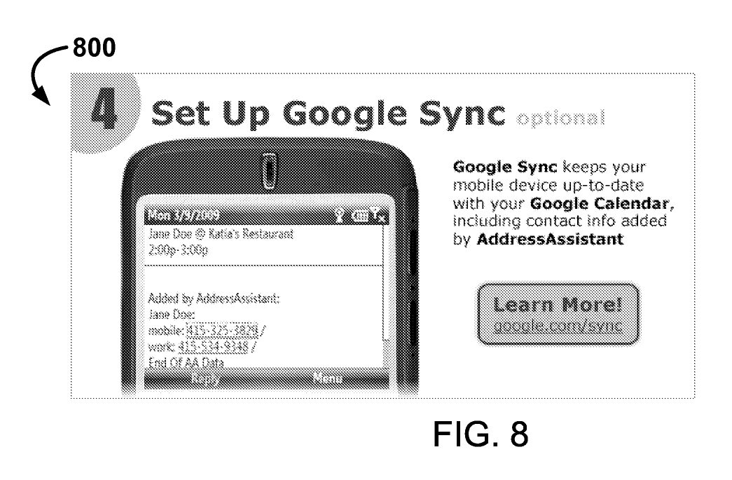

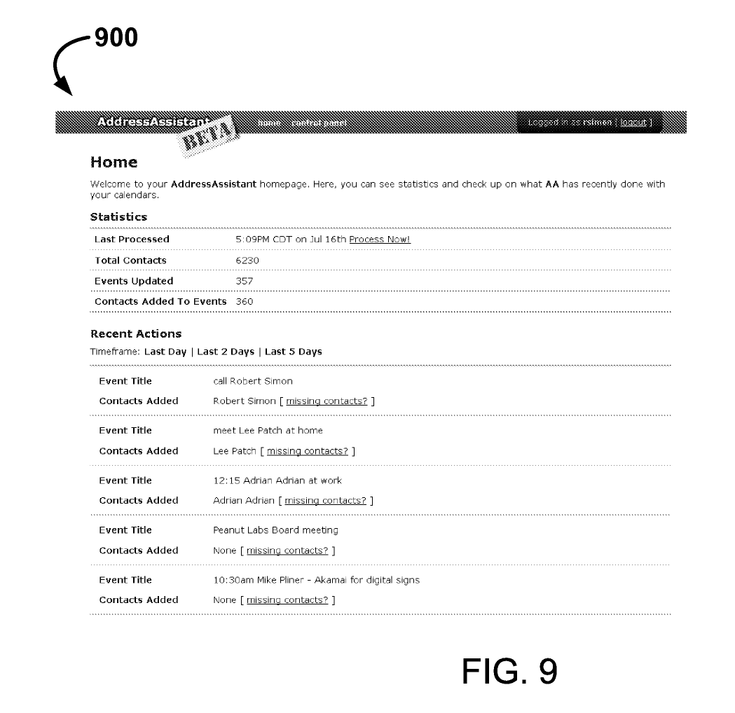

FIGS. 5 through 9 provide example screen shots for the creation of an account with the personal productivity assistant. FIG. 5 illustrates the creation of an account, including the generation of login information (shown generally at 500). Example screenshot seen at FIG. 6 illustrates the step of enabling the Personal Productivity Assistant 110 to have access to existing Personal Productivity Application 120 (shown generally at 600). The individual accounts that the Personal Productivity Assistant 110 is supposed to monitor may also be configured, as is illustrated in the example screenshot of FIG. 7. Also, mobile devices may be synchronized with the Personal Productivity Assistant 110, as seen in the example screenshot of FIG. 8. Lastly, as illustrated at the example screenshot of FIG. 9, a summary page may be presented to the user including recent activities, and usage statistics.

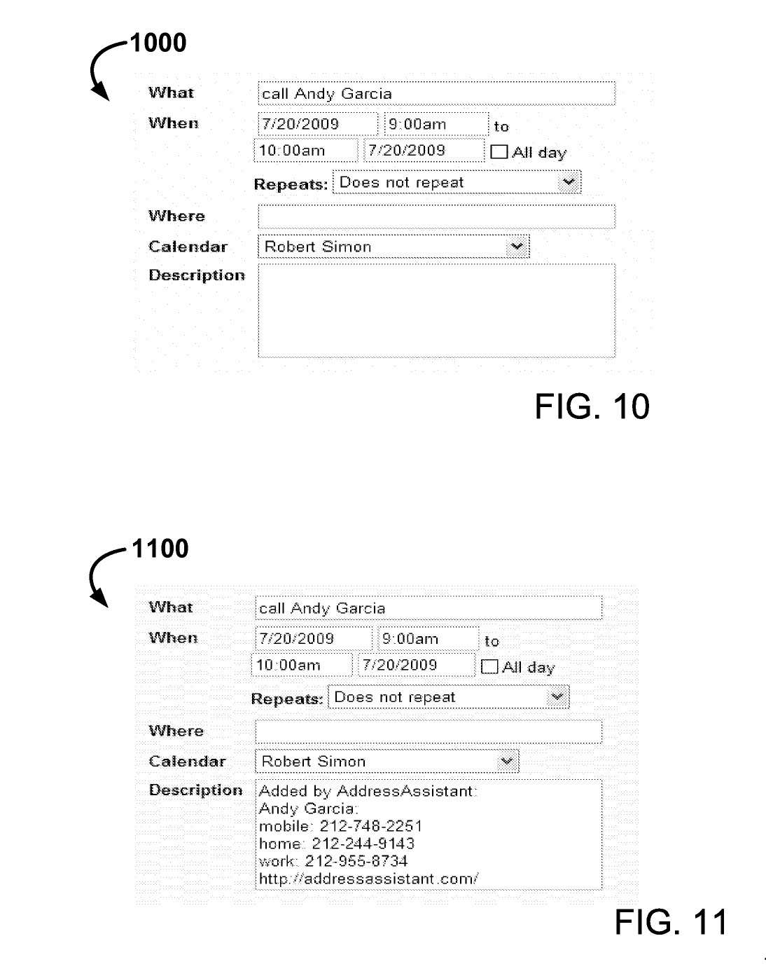

FIG. 10 provides a first example screen shot of a user entry in the personal productivity application, shown generally at 1000. In this screenshot, multiple fields are visible, including a ‘What’, ‘When’, ‘Where’, account indicator and a ‘Description’ of the entry. As can be seen the user entered in the phrase including the keyword “call” and the value “Andy Garcia”. Also the time is indicated.

FIG. 11, then, provides an example screen shot of the entry of FIG. 10 after being processed by the personal productivity assistant, shown generally at 1100. Here the Personal Productivity Assistant 110 referenced the local contact database for the value “Andy Garcia”. As the keyword here was “call”, contact information retrieved included the value's phone numbers, which are then populated into the description field of the entry, thereby augmenting the entry.

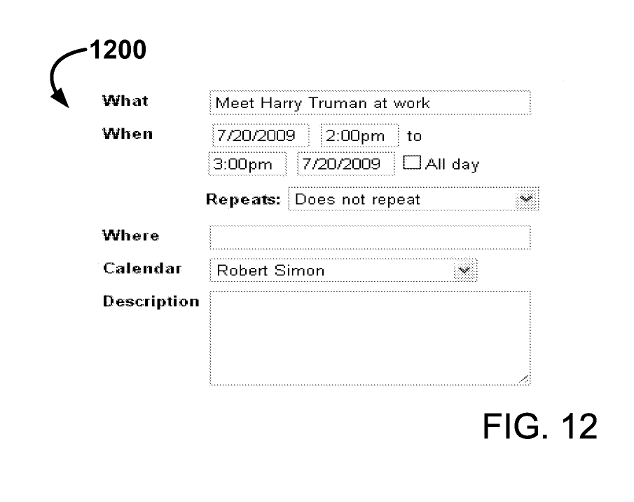

FIG. 12 provides another example screen shot of a user entry in the personal productivity application, shown generally at 1200. Much like the previous example, the ‘what’ and ‘when’ fields have information provided by the user. This new entry includes the keyword “meet” and two values, “Harry Truman” and “work”.

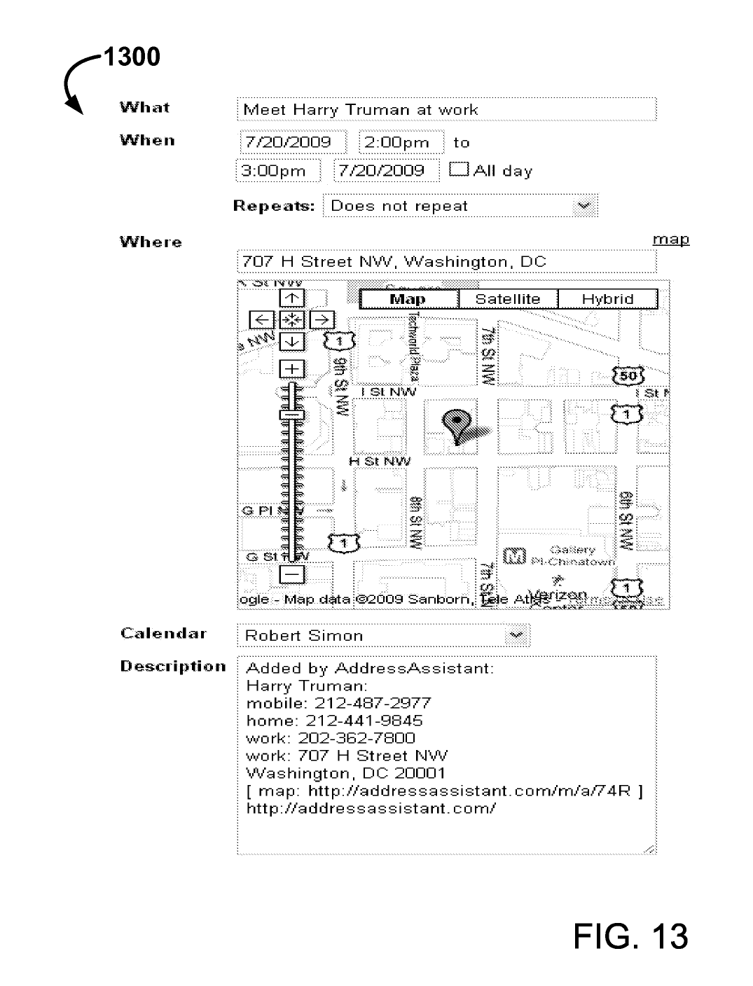

FIG. 13 provides an example screen shot of the entry of FIG. 12 after being processed by the personal productivity assistant, shown generally at 1300. This augmentation provides both contact information for the value “Harry Truman” but also includes location information for the value “work”. This location information may include an address and/or a map of the location.

“Work”, being a location descriptor, must be disambiguated by the system before a specific street address can be provided. This disambiguation may be achieved by searching for the location designator in the local contact databases. Typically, familiar location designators such as “home”, “work”, “Grandma's” and the like are stored within the contact databases.

If the location is not found within the contact database, an internet or similar search may be performed to determine the address of a particular location. This search may also be compared to the users current location (determined via GPS), last location (as determined from a prior appointment), future location (determined from the next appointment), or locality (determined as a set distance from work or home locations) in order to determine the exact street address of a particular location. If the system is still unable to disambiguate the location designator, then, in some embodiments, a message may be placed in the entry to indicate that further information is required to determine the entry's location data.

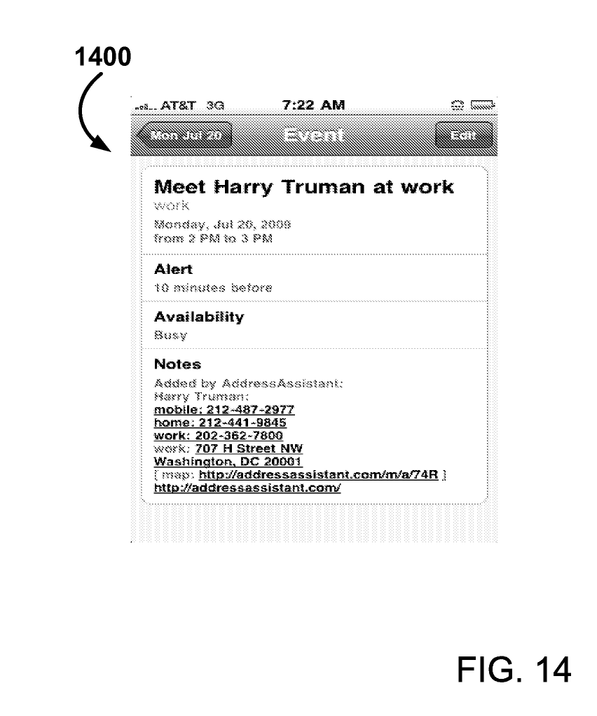

FIG. 14 provides an example screen shot of a message relayed to a mobile device in response to the entry of FIG. 12 after being processed by the personal productivity assistant, shown generally at 1400. This entry may be augmented to provide truncated information for easier viewing on a mobile device screen. Here the address is provided. Additionally, a link for directions and a map is likewise provided.

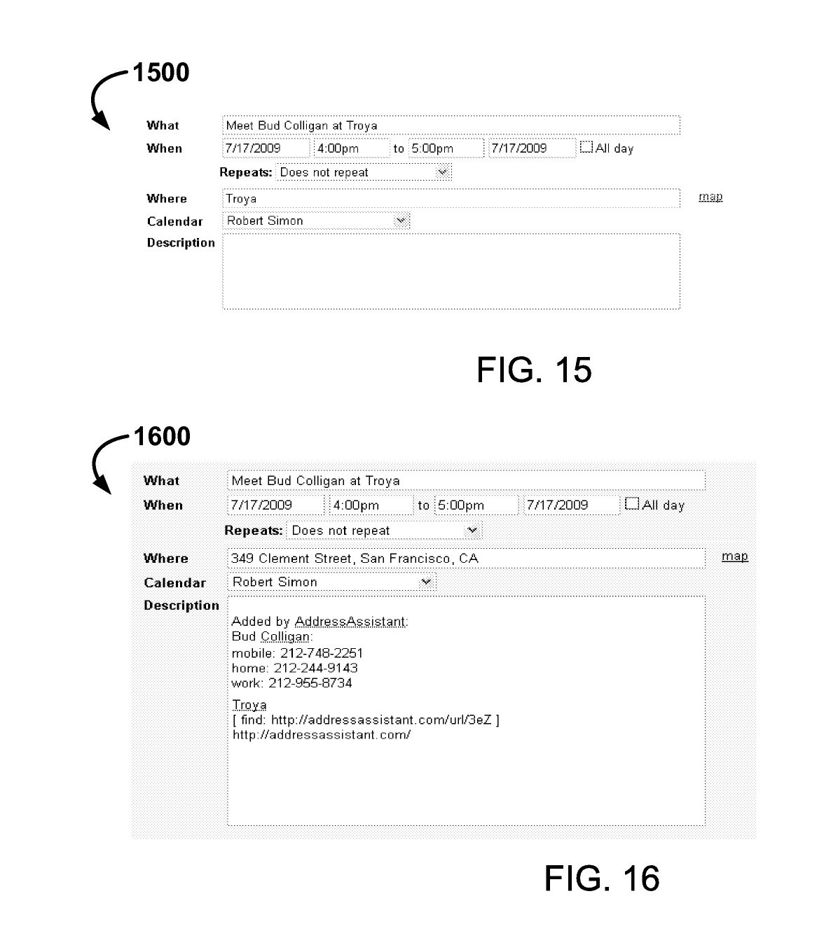

FIG. 15 provides another example screen shot of a user entry in the personal productivity application, shown generally at 1500. Again, the ‘what’ and ‘when’ fields are filled out as well as the ‘where’ field. The keyword of this example entry is “meet” and the values are “Bob Colligan” and “Troya”.

FIG. 16 provides an example screen shot of the entry of FIG. 15 after being processed by the personal productivity assistant, shown generally at 1600. Again, the contact information for the individual is collected from the local database and used to populate the entry. An internet search, in this example, may be utilized to disambiguate the location designator to generate a street address for the location. A map link may also be provided in the description portion of the entry.

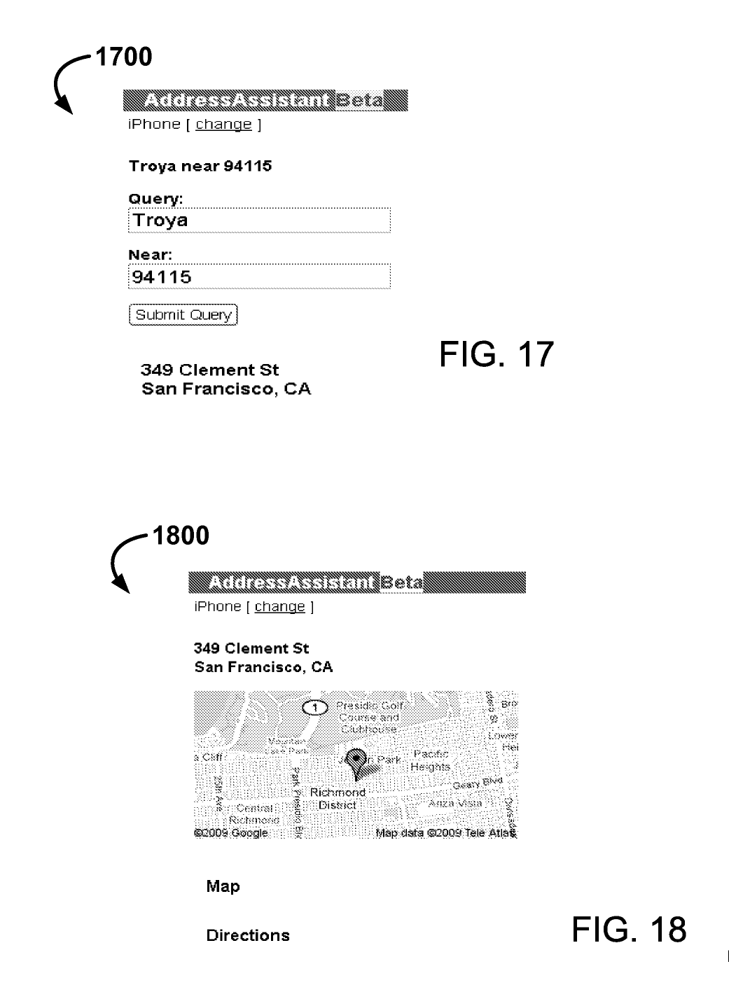

FIG. 17 provides an example screen shot of a message relayed to a mobile device in response to the entry of FIG. 15 after being processed by the personal productivity assistant, shown generally at 1700. The location designator may be inserted in a query field near a particular locality. This locality may be determined from GPS coordinates, other entries or the user's home or work address, among others. This query results in a street address, which is also displayed.

FIG. 18 provides an example screen shot of an update message relayed to a mobile device in response to a selection made by the user, shown generally at 1800. Again, this map may be generated in response to the query of the location designator in a known locality. A map may be presented to the user, as well as links to a more detailed map and directions to the location.

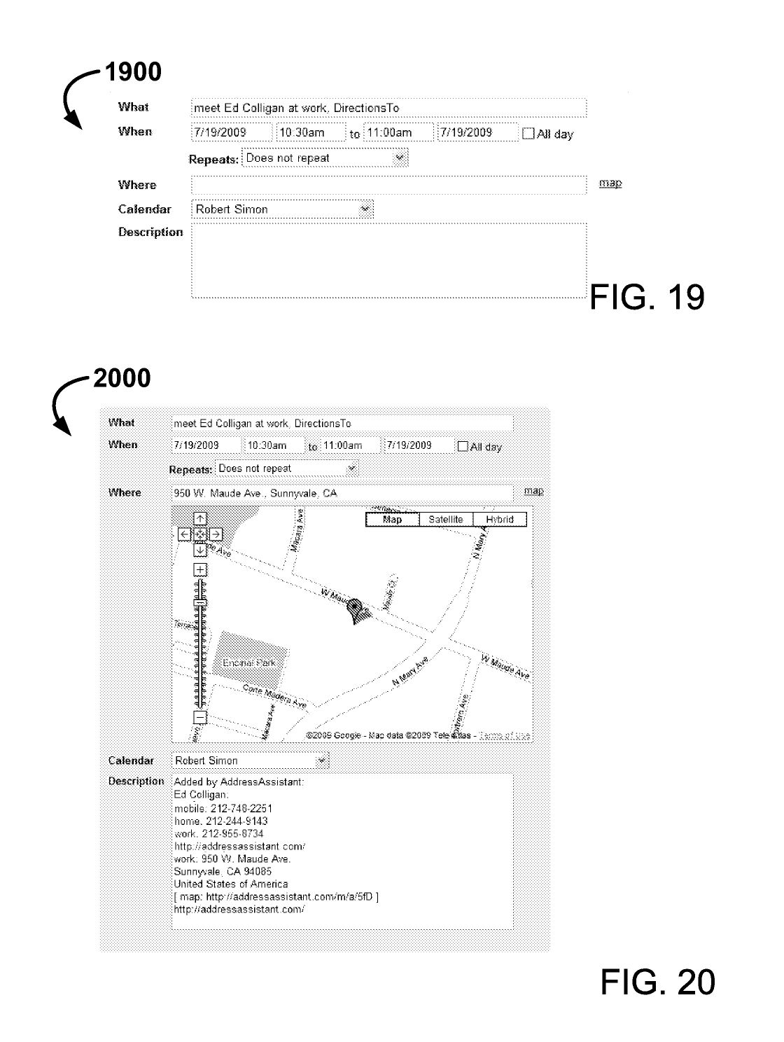

FIG. 19 provides another example screen shot of a user entry in the personal productivity application, shown generally at 1900. Here two keywords are identified: “meet” and “directions to”. Likewise, two values are identified: “Ed Colligan” and “work”. The value ‘Ed Colligan’ is associated with the keyword ‘meet’, whereas the value ‘work’ applies to both keywords ‘meet’ and ‘directions to’.

FIG. 20 provides an example screen shot of the entry of FIG. 19 after being processed by the personal productivity assistant, shown generally at 2000. As with previous examples, the value for the individual prompts the Personal Productivity Assistant 110 to search contact databases for contact information. The location value ‘work’ is disambiguated by searching contact addresses. The address for ‘work’ and a map is then provided as well.

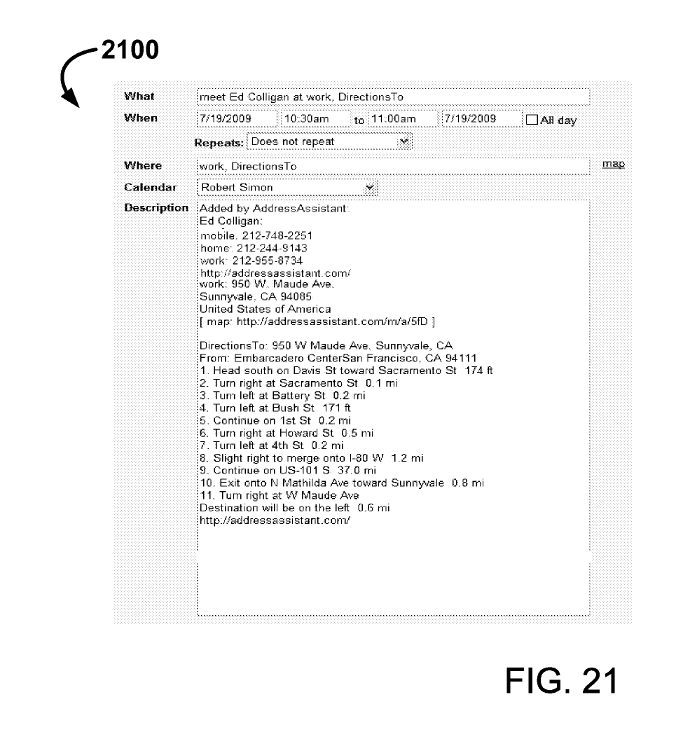

FIG. 21 provides another example screen shot of the entry of FIG. 19 after being processed by the personal productivity assistant, shown generally at 2100. In this example screenshot the keyword ‘directions to’ and the value ‘work’ initiates a search of a directions database. The start location for the directions may be the user's current location as determined via GPS, a known location such as home address or a city center, or the location of the previous entry (assuming it is the same day). Alternatively, the user may be given the opportunity to enter a separate starting location. In yet other embodiments, the system may set the starting location on the user's probable location by analyzing the time of the entry. For example, for a 7:00 AM meeting, the starting location for the directions would likely originate from the users house, because of the early hour. Likewise, a 6:00 PM meeting would likely come directly after work.

In sum, systems and methods for augmenting data within entries in a personal productivity application is provided. While the disclosed entry augmentation system has been discussed for use with a calendar application in many of the examples, it is also understood that the present entry augmenter has beneficial use in a wide range of programs where data entry is difficult and the user desires a greater wealth of information.

While this invention has been described in terms of several preferred embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for generating a display including information from disparate data sources on a device for a personal productivity application entry, useful in association with a contact database and a reference dataset output device, the method comprising:
receiving a set of values and a set of keywords, wherein the values are functionally related to the keywords;
analyzing the functional relationship between the values and keywords to generate the types of data to be displayed, wherein the types of data includes at least one of contact information, address information, mapping information, directions, and suggestions;
querying at least one local contact database for contact information and address information associated with the values;
querying at least one external reference database for mapping information, directions, and suggestions; and
aggregating the located contact information, address information, mapping information, directions, and suggestions into a single dataset for display on the device.

2. The method, as recited in claim 1, wherein the set of values and the set of keywords are configurable.

3. The method, as recited in claim 2, further comprising receiving user preferences, wherein the user preferences includes the configurations of the set of values and the set of keywords, and wherein the user preferences further includes display preferences and a configuration of which external reference databases to query.

4. The method, as recited in claim 3, wherein the aggregating the located contact information, address information, mapping information, directions, and suggestions into a single dataset further comprising prioritizing the information according to the display preferences.

5. A method for determining which data to display in a personal productivity application entry, useful in association with a contact database and a reference dataset, the method comprising:
receiving the personal productivity application entry;
parsing the personal productivity application entry for keywords;
parsing the personal productivity application entry for at least one value corresponding to each keyword, wherein values correspond to contact names found in the contact database and addresses; and
correlating the keywords and values to determine what data to display in the personal productivity application entry.

6. The method, as recited in claim 5, wherein the set of values and the set of keywords are configurable.

7. The method, as recited in claim 6, further comprising receiving user preferences, wherein the user preferences includes the configurations of the set of values and the set of keywords, and wherein the user preferences further includes display preferences and a configuration of which external reference databases to query.

8. The method, as recited in claim 7, wherein the correlating the keywords and values to determine what data to display further comprising prioritizing the data according to the display preferences.

9. The method, as recited in claim 5, further comprising populating the personal productivity application entry with the determined data, wherein said populating data includes at least one of phone number information, email addresses, contact notes and address information.

10. The method, as recited in claim 9, further comprising:
searching a mapping database for location information associated with the personal productivity application entry; and
displaying, within the personal productivity application entry, at least one of a map and directions from the mapping database.

11. A method for generating a display on a device for a personal productivity application entry, useful in association with a contact database and a reference dataset output device, the method comprising:
receiving data for displaying in the personal productivity application entry;
determining a subset of the data to be displayed in the personal productivity application entry, whereby the subset is determined by comparing the data display area, the device display area, user preferences and data type;
generating a link for remaining data; and
displaying the subset of data and the generated link in the personal productivity application entry.
